(19) United States
(12) Patent Application Publication
(10) Pub. No.: US 2004/0103272 A1
(43) Pub. Date: May 27, 2004

(54) Using a processor cache as RAM during platform initialization

(76) Inventors: Vincent J. Zimmer, Federal Way, WA (US); Michael A. Rothman, Gig Harbor, WA (US); Sham M. Datta, Hillsboro, OR (US)

Correspondence Address: Timothy N. Trop, TROP, PRUNER & HU, P.C., 8554 KATY FWY, STE 100, HOUSTON, TX, 77024-1841, US

(21) Appl. No.: 10/306,327

(22) Filed: Nov. 27, 2002

(51) Int. Cl. G06F 9/00

(52) U.S. Cl. 713/1

(57) ABSTRACT

Prior to the initialization of system memory, a processor cache may be utilized as a random access memory to permit more complex initialization protocols. For example, both data and instruction caches may be utilized to perform software functions involving higher level programming languages at early initialization stages.

### BACKGROUND

This invention relates generally to processor-based systems and, particularly, to techniques for initializing processor-based systems.

During the early initialization of a platform, permanent or system memory may not be available. Thus, sophisticated algorithms may not be executable until later stages of the platform initialization.

With ever more sophisticated platform initialization, there is a desire to have component software available in the early platform initialization stage. In addition, there are other early execution algorithms, such as the ability to provide for a signature check of the next chunk of memory or firmware, that may raise the need to have component software available.

As memory technologies migrate to higher speed interfaces, memory controllers and memory devices have become increasingly more complex to initialize. In addition, system-on-a-chip technology is also becoming increasingly sophisticated. For example, complex decision trees involving many configuration patterns describing the system, memory modules, and, in some cases, individual memory devices, are handled by the firmware to initialize the system memory.

Typically this initialization code has been written in a memoryless environment (i.e., assembly language using only on-processor registers as programming resources), resulting in custom code developed on a chipset by chipset basis that is often difficult to debug and maintain. Generally, the memory initialization algorithms have relatively limited feature sets and error handling. In addition, the use of platform hardware security devices, such as trusted platform module devices that support hashing functions and also store digital signature keys on a chip, cannot be used during early platform initialization.

Therefore, there is a need for ways to improve the processing capabilities during early platform initialization.

### BRIEF DESCRIPTION OF THE DRAWINGS

FIG. 1 is a schematic depiction of one embodiment of the present invention;

FIG. 2 is a schematic depiction of a system in accordance with one embodiment of the present invention; and

FIG. 3 is a flow chart for early platform initialization in accordance with one embodiment of the present invention.

### DETAILED DESCRIPTION

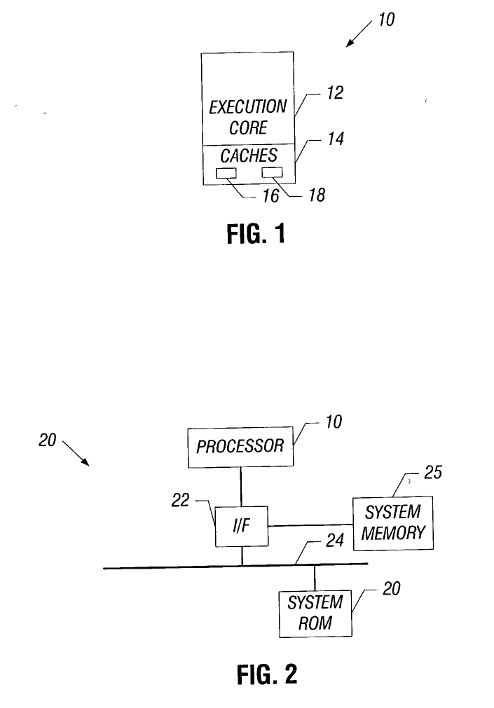

Referring to FIG. 1, a processor 10 may include an execution core 12 and a random access memory (RAM) 14 including one or more caches 16 and 18. In one embodiment, the processor 10 may be the Intel XScale™ processor and the caches 16 and 18 in such case may be instruction and data caches associated with the XScale™ processor. However, the present invention is not limited to any particular microarchitecture.

Referring to FIG. 2, a processor-based system 20 may incorporate the processor 10, an interface 22 that couples the processor 10 to a bus 24 and a system read only memory (ROM) 20. The system read only memory 20 typically stores the basic input/output system (BIOS) of the processor-based system 20.

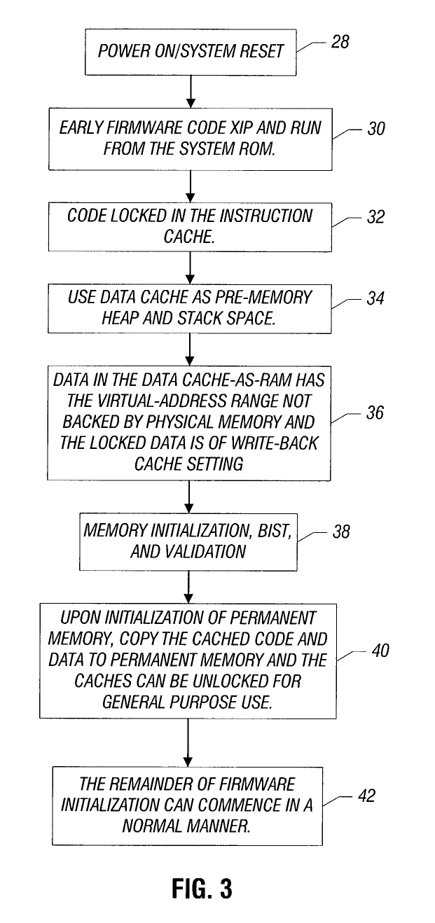

The early initialization firmware, shown in FIG. 3, may run out of the system ROM 20. The initial contents of the initialization process, prior to the availability of system memory 25, may be stored in the caches 16 and 18 on the processor 10. The caches 16 and 18 may act as static random access memory for the early platform initialization in some embodiments. Upon power-on or system reset, as indicated in block 28, the early firmware code may be executed in place (XIP) and run directly from the system ROM 20 as indicated in block 30.

Some of this early firmware code may be locked in the instruction cache 16 as indicated in block 32. The instruction cache 16 may be enabled and translation may be enabled to initiate locking for dedicated use in initialization in some embodiments.

For example, in the Intel XScale™ processor, up to 28 cache lines can be locked in a set. Any attempt to lock more than 28 cache lines in a set may be silently ignored. The code that performs the locking is cache inhibited. Instruction cache line fills cannot occur while the locking activity is in progress. As a result, care should be taken in the placement of the code that performs the locking. Advantageously, that code should not reside too close to a cacheable region from which a prefetch may occur. Thus, the locking code may be maintained outside of 128 bytes of a cache for region. The contents of the cache remain valid after locking.

Data may also be locked in the data cache 18. In addition to the early code load into the instruction cache 16, some data may be stored in the data cache 18 to provide early heap and stack space.

In an embodiment using an XScale™ processor, cache lines may also be locked in the data cache 18. Up to 28 cache lines may be locked in a set in one example. Again, any attempt to lock more than 28 cache lines in a set may be silently ignored. Data may be locked in the data cache 18 using data locking, but this locking technique involves the use of virtual addresses backed up by physical memory.

Alternatively, data RAM locking allows the definition of a virtual address range that is not backed by physical memory may be utilized. While locked data may be either write back or write through, the data RAM is write back. Although the virtual range defined as data RAM does not get backed up by physical memory, the page-table descriptors are completed so that the necessary permission checking can be performed.

Thus, as shown in block 34 in FIG. 3, the data cache 18 may be used as a preliminary heap and stack space. In one embodiment, data in the data cache 18, functioning as a cache-as-RAM, has a virtual address range not backed by physical memory using data RAM locking. “Cache-as-RAM” (CAR) is also referred to as “No-eviction Mode” (NEM) in that it describes a modality where the data is not evicted from the cache. The locked data is of a write back cache setting to prevent attempts to flush to system memory that does not yet exist, as indicated in block 36. An advantageous virtual address range is chosen that will not be decoded subsequently by the memory controller because if there were an inadvertent eviction of a cache line it is desirable to avoid the generation of an exception after transitioning to system memory. A more sophisticated method of memory initialization can commence as well as built-in-self-test (BIST) and other sophisticated validation methodologies as indicated in block 38.

The code and data locked in the caches 16, 18 may optionally run as an algorithm to authenticate permanent or system memory 25 initialization code. The permanent or system memory 25 initialization code, if authenticated, also uses the above-listed code and data locking to run from the caches 16, 18. This code may initialize the system memory complex which may include, but is not limited to, synchronous dynamic random access memory (SDRAM), double-rate random access memory (DDR) or RAMBUS DRAM (RDRAM). This authentication mechanism describes an inductive chain of trust in a modular firmware architecture. Herein, a component A receives control; it authenticates the next component B before passing control to B; B in turn authenticates C prior to passing control. A trusting B and B trusting C leads to A trusting C. A can be the “boot-block” code in the firmware that receives, the reset vector, B can be the Core dispatcher, and C can be the chipset initialization code, for example. Possible signature algorithms include the Digital Signature Standard (DSS).

Upon initialization of permanent or system memory 25, the cache code and data may be copied to permanent or system memory 25. The caches 16, 18 can be unlocked for general purpose use as indicated in block 40.

Thus, a processor cache may be used as a temporary, randomly accessible data store during the pre-system memory environment. These techniques may provide a way to migrate additional algorithmic complexity from hardware state machines and microcode into firmware in some cases. This migration may be accomplished by having the primordial processor state support running firmware that can be written in higher level programming languages, such as C, that use a heap and a stack. The use of higher level languages may allow for sophisticated algorithms to be encoded in this early phase of execution. Using a cache-as-RAM approach may also result in saving die space and validation by migrating features, such as the built-in-self-test (BIST), to this early, temporary memory based code, in some embodiments.

Many digital signature algorithms require more than ten kilobytes of data store in order for reasonable implementations. A processor cache may implement such digital signature algorithms without expensive cryptographic coprocessors, typically used when signature algorithms are needed.

As the system-on-a-chip becomes even more complicated, with internal buses and various peripherals attached, the ability to do enumeration, resource balancing, and programming of these devices may require more state information and sophisticated firmware flows. The use of the processor cache-as-RAM without permanent memory backing allows for execution of such complicated system-on-a-chip protocols in some embodiments.

Thus, firmware for the pre-system memory initialization environment may be written in higher level languages that require a memory stack in accordance with some embodiments of the present invention. More exotic DRAM technology and more complicated system-on-a-chip topologies may be used in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
prior to the initialization of system memory, using a processor cache to initialize a processor-based system; and
locking a cache line in said cache without system memory backing.

2. The method of claim 1 including using a processor data cache to initialize a processor-based system.

3. The method of claim 1 including using a processor instruction cache to initialize a processor-based system.

4. The method of claim 1 including using both a processor instruction cache and a processor data cache to initialize the processor-based system.

5. The method of claim 1 including using the data cache to provide a heap and stack space.

6. The method of claim 1 including running initialization code from a system read only memory.

7. The method of claim 6 including execution in place code from the system read only memory.

8. The method of claim 1 including releasing said cache line after initialization.

9. The method of claim 1 including copying code used for initialization from said processor cache to system memory.

10. The method of claim 1 including sharing a virtual address range that cannot be decoded after transitioning to system memory.

11. The method of claim 1 including using a write-back cache setting for said cache line.

12. An article comprising a medium storing instructions that, if executed, enable a processor-based system to:
use a processor cache prior to the initialization of system memory to initialize the processor-based system; and
lock a cache line in said cache without system memory backing.

13. The article of claim 12 further storing instructions that, if executed, enable the processor-based system to use a processor data cache to initialize the processor-based system.

14. The article of claim 12 further storing instructions that, if executed, enable the processor-based system to use a processor instruction cache to initialize the processor-based system.

15. The article of claim 12 further storing instructions that, if executed, enable the processor-based system to use both a processor instruction cache and a processor data cache to initialize the processor-based system.

16. The article of claim 12 further storing instructions that, if executed, enable the processor-based system to use the data cache to provide a heap and stack space.

17. The article of claim 12 further storing instructions that, if executed, enable the processor-based system to run initialization code from a system read only memory.

18. The article of claim 17 further storing instructions that, if executed, enable the processor-based system to execute in place code from the system read only memory.

19. The article of claim 12 further storing instructions that, if executed, enable the processor-based system to release said cache line after initialization.

20. The article of claim 12 further storing instructions that, if executed, enable the processor-based system to copy the cache line to system memory.

21. The article of claim 10 further storing instructions that, if executed, enable the processor-based system to share a virtual address range that cannot be decoded after transitioning to system memory.

22. The article of claim 10 further storing instructions that, if executed, enable a processor-based system to set the cache line to write-back.

23. The system comprising:
a processor including a processor cache;
a system memory coupled to said processor; and
a system read only memory coupled to said processor, said system read only memory storing instructions that are executable in place to initialize the system prior to initialization of the system memory using the processor cache and to lock a cache line without memory backing.

24. The system of claim 21 wherein said processor cache is a data cache.

25. The system of claim 21 wherein said processor cache is an instruction cache.

26. The system of claim 23 including a heap and stack space provided by said processor cache.

27. The system of claim 26 wherein said processor cache is a data cache.

28. The system of claim 23 wherein said instructions enable releasing the cache line after initialization.

29. The system of claim 23 wherein said instructions enable the cache line to be copied to system memory.

30. The system of claim 23 wherein said instructions set the cache line to write-back.
